(19) United States
(12) Patent Application Publication
(10) Pub. No.: US 2002/0071939 A1
(43) Pub. Date: Jun. 13, 2002

(54) Antislip fabric and strips of such fabric

(76) Inventors: Tadoru Tomiyasu, Tsubukuhon-machi (JP); Keisuke Tomiyasu, Kurume-shi (JP)

Correspondence Address: JONES, TULLAR & COOPER, P.C., P. O. Box 2266, Eads Station, Arlington, VA, 22202, US

(21) Appl. No.: 09/808,034

(22) Filed: Mar. 15, 2001

(30) Foreign Application Priority Data
Mar. 17, 2000 (JP) 2000-077102

(51) Int. Cl. B32B 23/02; D03D 15/00

(52) U.S. Cl. 428/193; 442/187; 442/190; 442/203; 442/208; 442/209

(57) ABSTRACT

An improved antislip strip or band is disclosed which can maintain shirt or blouse in place with respect to slacks, pants, trousers or skirt while being worn. The strip includes a body portion formed of an elastic, antislip fabric comprising two different warp threads of polyurethane double covered yarn and polyurethane bare yarn interlaced with weft threads in the form of leno weave, and two opposed edge portions in the form of plain weave. The weaving is done in the antislip fabric to provide a roughened or irregular surface having a plurality of spaced-apart nubs formed on both sides of each gap between two adjacent weft threads. The antislip strip may be sewn into the waist portion of a garment with the roughened or irregular surface facing inside.

### BACKGROUND OF THE INVENTION

The present invention relates to the field of garment or clothes and, more particularly, to an antislip fabric, strips of such fabric useful in maintaining the wearer's clothes in place to prevent inadvertent displacement of clothing as they are worn, and garments having such strips. More particularly, such antislip fabric may be sewn in the inner waist portion of trousers, pants, slacks or skirt to prevent unwanted “ride” or movement of shirt or blouse with respect thereto.

When a person bends his or her body, or straightens his or her back, shirt or blouse has a tendency to gather or ride out of position, creating a disheveled and unsightly look due to unwanted excess of material outside of the slacks, trousers or skirt. Therefore, slacks, trousers or skirt must be readjusted almost every time a person stands from a sitting position.

Various attempts have been made to maintain the shirt or blouse in proper position with respect to slacks, trousers or skirt, including attachment of a separate antislip strip to the waist portion of the garment. Such antislip strips comprise an elastic rubber braid sewn into a fabric tape in such a manner as to form a frictional surface having a plurality of spaced-apart nubs thereover. The frictional surface serves as retaining means for resisting displacement of adjacent garments so that movement of the wearer will not displace the garments with respect to each other.

However, such conventional antislip strips have certain drawbacks as set forth below. First, they do not resist slippage in a satisfactory manner because the nubs are formed on the fabric strip by sewing an elastic rubber braid in a zig-zag manner. One attempt to overcome this deficiency of the conventional strips is to increase the width of the strips for enhanced sliding resistance. However, this will render the strip undesirably bulky. Secondly, antislip strips of increased width do not provide adequate air-permeability between the wearer's body and slacks, trousers or skirt. Thirdly, when subjected to a dry cleaning process, such antislip strips become sticky and virtually lose their inherent sliding resistance as the rubber braids deteriorate due to attack by solvent.

### SUMMARY OF THE INVENTION

Therefore, it is the main object of the present invention to overcome the above-said drawbacks of the prior art and provide improved antislip fabric and strips of such fabric useful in maintaining the wearer's clothes in place to prevent inadvertent displacement of clothing as they are worn.

It is another object of the present invention to provide such antislip fabric which may be sewn into the waist portion of trousers, pants, slacks or skirt to prevent unwanted “ride” or movement of shirt or blouse with respect thereto.

It is a further object of the present invention to provide such an antislip fabric which is highly resistant to solvent during dry cleaning.

The above and other objects can be achieved in accordance with the present invention which is directed to an improved antislip fabric of the type capable of maintaining garments such as trousers and shirt or skirt and blouse in place with respect to each other, comprising two different warp threads interlaced with weft threads in the form of leno weave. In a preferred embodiment of the invention, one of the two different warp threads is polyurethane bare yarn and the other of the two different warp threads is polyurethane double covered yarn. Also, the weft threads are polyester monofilament. The weaving is done to provide a roughened or irregular surface having a plurality of spaced-apart nubs formed on both sides of each gap between two adjacent weft threads. The plurality of spaced-apart nubs are formed by interlacing loose warp threads of polyurethane bare yarn and weak tensioned warp threads of polyurethane double covered yarn with weft threads.

According to a different aspect of the invention, there is provided an antislip strip useful in maintaining garments such as trousers and shirt or skirt and blouse in place with respect to each other, wherein the strip is formed of an antislip fabric comprising two different warp threads interlaced with weft threads in the form of leno weave. In this embodiment, one of the two different warp threads is polyurethane bare yarn and the other of the two different warp threads is polyurethane double covered yarn. Also, the weft threads are polyester monofilament. The antislip strip further comprises two opposed edge portions in the form of plain or hollow weave, which comprises warp threads of polyester filament and woolie polyester interlaced with weft threads of polyester monofilament.

In the following detailed description of the invention, reference is made to the accompanying drawings which form a part hereof, and in which is shown, by way of illustration, specific embodiments in which the invention may be practiced.

The term “leno weave” used in the following description includes “plain weave” in which rotating warp threads are moved with respect to stationary warp threads every time they are interlaced with a weft thread, and “gauze weave” in which rotating warp threads are moved with respect to stationary warp threads every time they are interlaced with a group of three, five or seven weft threads. The term “lower garments” is understood to include all garments for covering the lower part of the body, such as trousers, slacks, pants, skirts, hakamas or the like. The term “kimono” is also used to encompass underwear and underskirts for Japanese-style kimono.

### BRIEF DESCRIPTION OF THE DRAWINGS

FIG. 1 is a perspective view of a rolled tape formed of antislip fabric embodying the present invention;

FIG. 2 is a schematic diagram showing the front face of the antislip fabric shown in FIG. 1;

FIG. 3 is a cross-sectional view as taken along lines I-I of FIG. 2;

FIG. 4 is a front view of a strip of antislip fabric attached to an inner waist portion of slacks;

FIG. 5 is a top plan view of an under-sash formed of the antislip fabric embodying the invention; and

FIG. 6 a view useful in explaining how the under-sash of FIG. 5 is used on Japanese-style traditional kimono.

### DESCRIPTION OF THE PREFERRED EMBODIMENT

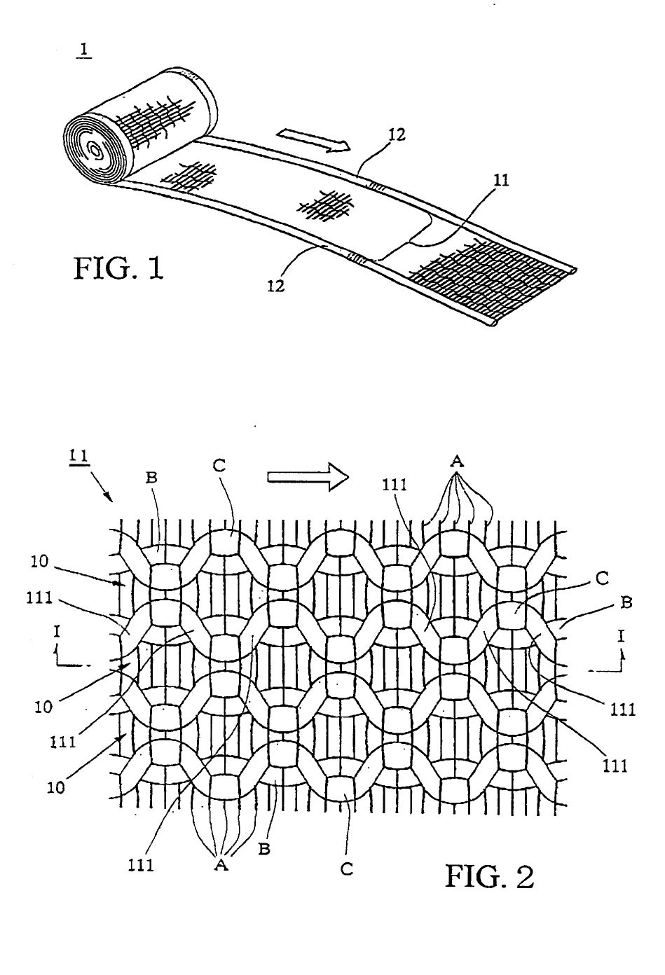

Referring now to the drawings and particularly to FIG. 1, there is shown a rolled tape 1 of antislip fabric as constructed in accordance with the present invention. The tape 1 has a body portion 11 in the form of “leno weave” and two opposed edge portions 12 in the form of “plain weave”. It has a width of 35 mm and is extensible or elastic along the length thereof. It should be noted that when the fabric is produced on a weaving machine, the upper surface as viewed in FIG. 1 actually faces upwardly in the machine and also that warp threads extend longitudinally of the tape, or along the arrow as shown in FIG. 1.

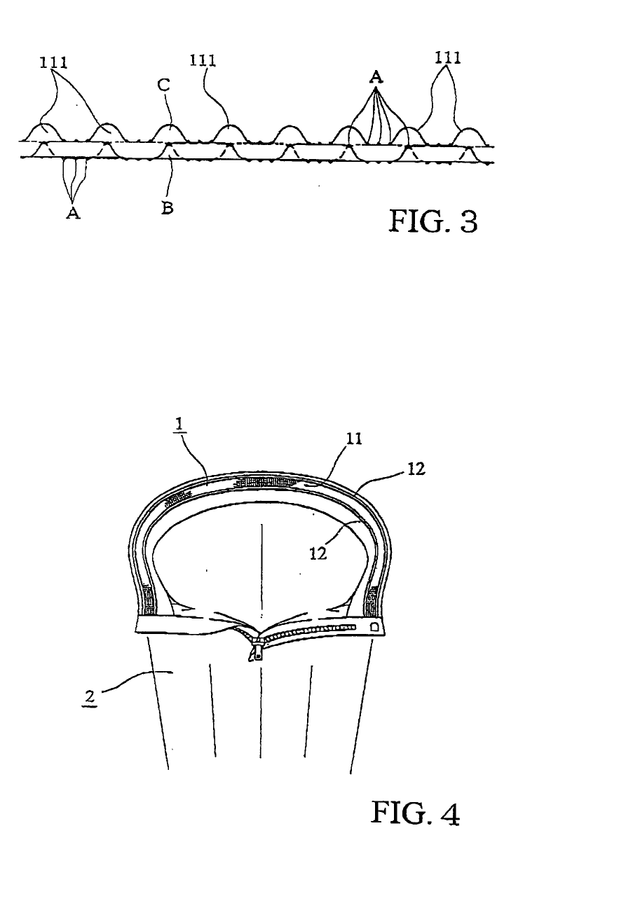

Referring to FIGS. 2 and 3, the body portion 11 of the tape 1 comprises weft threads A of polyester monofilament, warp threads B of polyurethane double covered yarn and another warp threads C of polyurethane bare yarn, both of which warp threads B, C are interlaced with the weft thread A in the form of the leno weave. The polyurethane double covered yarn used as warp threads B comprises a polyurethane bare yarn having polyester fiber wound therearound to form a double layered coil. Examples of the polyurethane bare yarn used as warp threads C includes yarn products having a denier of 840 (HS high-soft, clear type) sold by Asahi Chemical Co., Ltd. under the trademark “ROICA”. In the illustrated embodiment, the fabric is woven with a spacing of about 2 mm between warp threads and a gap 10 between weft threads so as to provide adequate air-permeability. However, it should be understood that the present invention is not limited to these spacings between two adjacent warp or weft threads.

In the body portion 11 of the leno weave, it should be noted that warp threads B of polyurethane double covered yarn and warp threads C of polyurethane bare yarn are interlaced with each other to provide a roughened or irregular surface on the fabric tape 1 that serves to resist slippage. In a preferred embodiment of the present invention, the antislip fabric is woven by interlacing weak tensioned warp threads B of polyurethane double covered yarn and somewhat loose warp threads C of polyurethane bare yarn with each other to provide a plurality of spaced-apart nubs 111 of the loose polyurethane bare yarn formed on the polyurethane double covered yarn. As described above, the spaced-apart nubs 111 are formed of the polyurethane bare yarn which has a high frictional resistance. Accordingly, the antislip fabric according to the invention has a frictional surface with a higher frictional resistance than conventional antislip tapes comprising a rubber braid sewn into a cloth tape. The two opposed edge portions 12 of the antislip strip 1 are woven in the form of plain weave by using polyester monofilament as weft threads and polyester filament and woolie polyester as warp threads.

FIG. 4 is a perspective view of the portion of a pair of slacks having the antislip strip 1 attached to the inner waist portion thereof The antislip strip 1 is sewn into the waist portion with its roughened or irregular surface facing inside of the slacks. In the preferred embodiment of the invention, the sewing of the antislip strip 1 in the waist portion may be done without stretching the strip. With this antislip strip attached, any pull on a blouse or a skirt will be resisted by the antislip strip due to frictional engagement of the roughened surface against the blouse or the skirt.

Since the antislip strip 1 is in the form of leno weave, it is of less thickness than the conventional two-layered strip comprising a rubber braid sewn into a cloth tape. Further, the body portion 11 of the antislip strip 1 has gaps 10 formed between each two adjacent weft threads, which means a less density and weight than the conventional two-layered tape. Thus, the antislip strip 1 is light in weight and not bulky.

The body portion 11 of the antislip strip 1 has the roughened or irregular surface formed by alternate arrangement of nubs 111 and gaps 10 as best seen in FIG. 3 This will provide adequate air-permeability and hence prevent the strip from becoming stuffy.

The antislip strip 1 employs polyurethane bare yarn C which is highly resistant to solvent for dry cleaning so that subjecting the garments having such antislip strips attached to repeated dry cleaning would not distract from sliding resistance.

In the embodiment shown in FIG. 4, the antislip strip 1 is attached to the waist portion of the slacks so as to entirely surround it. However, it may be preferable to use more than one shorter antislip strip to partially surround the waist portion of the slacks so that the girth of the slacks may be conveniently adjusted.

In the illustrated embodiment, the antislip strip 1 is elastic and extensible along the length thereof However, the antislip strip 1 may not necessarily be elastic.

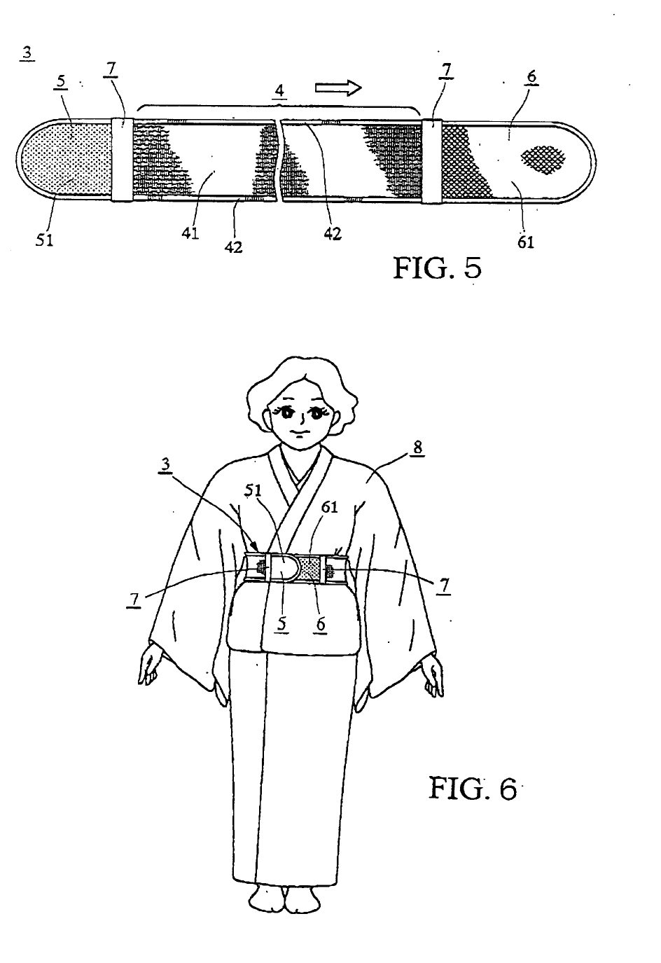

Referring to FIG. 5, an under-sash 3 for maintaining Japanese-style kimonos in place while being worn is shown with its intermediate portion cut away for clarity of illustration. The under-sash 3 has a considerable width and is of adequate length to surround the abdominal or breast portion of the wearer. In the illustrated embodiment, the under-sash is about 95 mm wide and about 700 mm long. However, the invention is not limited to these dimensions.

The under-sash 3 comprises a body portion 4 having the antislip strip of the invention attached thereto and fastener portions 5 and 6 formed in the opposite ends of the under-sash. The body portion 4 is generally in the form of leno weave at 41 but its opposite edge portions 42 are in the hollow weave. The edge portions 42 comprise weft threads of polyester monofilament and warp threads of polyester filament and woolie polyester, both interlaced with each other in the form of hollow weave.

As shown in FIG. 5, the under-sash 3 has a releasable fastening means, i.e., a sash clip 5 attached to one end thereof which is in the form of a hook-type surface fastener 51, and a sash clip 6 attached to the other end thereof which comprises a loop-type surface fastener 61. Designated at 7 are cloth portions which act to reinforce the attachment portions between the body portion 4 and the sash clips 5 and 6. The body portion 4 of the under-sash 3 is woven to be elastic in the longitudinal direction as shown by the arrow in FIG. 5. The releasable fastening means permits adjustment of fastening strength by changing the relative position of the sash clips 5 and 6.

Referring to FIG. 6, a woman is shown wearing a kimono with an under-sash 3 surrounding her body just below her breast portion. Prior to putting on the under-sash 3, it may be preferable to slightly stretch it so that the inner roughened or irregular surface of the under-sash can retain the kimono in place. The nubs on the roughened or irregular surface are formed of polyurethane bare yarn to provide enhanced sliding resistance.

To capitulate the important features and the resultant advantages of the present invention:

(a) The present invention provides an improved antislip fabric which comprises at least two different warp threads interlaced with weft threads in the form of leno weave to provide a roughened or irregular surface having a plurality of spaced-apart nubs formed thereon to resist slippage. The plurality of nubs formed by interweaving the two different warp threads provides enhanced sliding resistance.

(b) Providing a strip of the present antislip fabric on the waist portion of a lower garment such as slacks or skirt serves to maintain or retain shirt or blouse in place with respect to the slacks or skirt to prevent inadvertent displacement or dislodgement of such garments as they are worn.

The antislip strip is in the form of leno weave so that it is less thick than conventional two-layered antislip tapes having a rubber braid sewn into a cloth tape. Further, the antislip strip of leno weave has gaps between each two adjacent weft threads thereby providing less density and weight than such conventional two-layered antislip tapes. Furthermore, the roughened or irregular surface of the antislip strip has a plurality of spaced-apart nubs formed between such gaps to provide adequate air-peameability.

(c) The present invention provides an antislip fabric using polyurethane bare yarn which is resistant to solvent for dry cleaning.

Accordingly, the enhanced sliding resistance afforded by this polyurethane bare yarn will not deteriorate through repeated dry cleaning processes.

While the description above relates to particular embodiments of the present invention, it will be understood that many modifications may be made without departing from the spirit thereof. The presently disclosed embodiments are therefore to be considered in all aspects as illustrative and not restrictive, the scope of the invention being indicated by the appended claims, rather than the foregoing description, and all changes which come within the meaning and range of equivalency of the claims are therefore intended to be embraced therein.

What is claimed is:

1. An antislip fabric of the type capable of maintaining garments such as trousers and shirt or skirt and blouse in place with respect to each other, the antislip fabric comprising two different warp threads interlaced with weft threads in the form of leno weave.

2. The antislip fabric as set forth in claim 1 wherein one of the two different warp threads is polyurethane bare yarn.

3. The antislip fabric as set forth in claim 2 wherein the other of the two different warp threads is polyurethane double covered yarn.

4. The antislip fabric as set forth in claim 1 wherein the weft threads are polyester monofilament.

5. The antislip fabric as set forth in claim 1 wherein the weaving is done to provide a roughened or irregular surface having a plurality of spaced-apart nubs formed on both sides of each gap between two adjacent weft threads.

6. The antislip fabric as set forth in claim 5 wherein the plurality of spaced-apart nubs are formed by interlacing loose warp threads of polyurethane bare yarn and weak tensioned warp threads of polyurethane double covered yarn with weft threads.

7. An antislip strip useful in maintaining garments such as trousers and shirt or skirt and blouse in place with respect to each other, wherein the antislip strip comprises two different warp threads interlaced with weft threads in the form of leno weave.

8. The antislip strip as set forth in claim 5 wherein one of the two different warp threads is polyurethane bare yarn.

9. The antislip strip as set forth in claim 6 wherein the other of the two different warp threads is polyurethane double covered yarn.

10. The antislip strip as set forth in claim 5 wherein the weft threads are polyester monofilament.

11. The antislip strip as set forth in claim 5 further comprising two opposed edge portions in the form of plain or hollow weave.

12. The antislip strip as set forth in claim 9 wherein the two opposed edge portions comprises warp threads of polyester filament and woolie polyester interlaced with weft threads of polyester monofilament.

13. The antislip strip as set forth in claim 7 wherein the weaving is done in the fabric to have a roughened or irregular surface formed thereon, the roughened or irregular surface having a plurality of spaced-apart nubs formed on both sides of each gap between two adjacent weft threads.

14. The antislip stip as set forth in claim 7 wherein the plurality of spaced-apart nubs are formed by interlacing loose warp threads of polyurethane bare yarn and weak tensioned warp threads of polyurethane double covered yarn with weft threads.
